(19) United States
(12) Patent Application Publication
(10) Pub. No.: US 2015/0197858 A1
(43) Pub. Date: Jul. 16, 2015

(54) FABRICATION OF THREE-DIMENSIONAL HEAT TRANSFER ENHANCING FEATURES ON A SUBSTRATE

(71) Applicant: BRAYTON ENERGY CANADA, INC., Gatineau (CA)

(72) Inventors: Antoine Corbeil, Gatineau (CA); Patrick Richer, Gatineau (CA); Bertrand Jodoin, Ottawa (CA); Yannick Cormier, Ottawa (CA); Philippe Dupuis, Ottawa (CA)

(73) Assignee: BRAYTON ENERGY CANADA, INC., Gatineau, QC (CA)

(21) Appl. No.: 14/417,457

(22) PCT Filed: Jul. 24, 2013
(86) PCT No.: PCT/CA2013/000665

§ 371 Date: Jan. 26, 2015

(30) Foreign Application Priority Data
Jul. 24, 2012 (GB) 1213165.2

(51) Int. Cl. C23C 24/04; B05B 7/14; B05B 15/04; C23C 4/00

(52) U.S. Cl. CPC C23C 24/04; C23C 4/005; B05B 7/1486; B05B 15/045

(57) ABSTRACT

Disclosed is a method and apparatus of fabricating three-dimensional heat transfer enhancing features on a surface of a substrate, the three-dimensional heat transfer enhancing features having a predetermined desired shape on a surface of a substrate. A mask is supplied, the mask having a pattern formed therein. The pattern is selected based on the predetermined desired shape of the three-dimensional heat transfer enhancing features to be fabricated. A jet of impinging coating particles is sprayed through the mask towards the substrate. A portion of the jet is selectively blocked with the pattern in the mask to fabricate the three-dimensional heat transfer enhancing features on the substrate.

### FIELD OF THE INVENTION

The present invention relates to engineering, manufacturing, heat transfer, surface and coatings technology. More specifically, the present invention relates to Fabrication of three-dimensional heat transfer enhancing features on a substrate by means of kinetic spray coating deposition through a mask.

### BACKGROUND OF THE INVENTION

Many applications require the use of extended surfaces such as fins to promote heat transfer. Fin arrays are typically attached to a surface (by techniques such as brazing or a conductive adhesive) or machined from the surface directly. All of these techniques can become labour intensive and time consuming, thereby leading to additional costs. Also, any imperfection in the bond/contact between the fins and the surface results in reduced fin heat transfer efficiency. The objective of the proposed technology is to offer an alternative approach to the manufacturing of heat transfer enhancing features that can be cost effective, easily automated and can ensure conformal contact between the fins and the surface.

It is common practice in the field of thermal spraying to mask portions of a component prior to its spraying in order to avoid coating deposition on the masked region. However, the mask typically consists of tape that is applied directly onto the part with the intention of completely blocking off all impinging coating material on the masked region.

### SUMMARY OF THE INVENTION

Embodiments of this invention solve the problem of time consuming attachment of poorly contacting heat transfer enhancing features on components by spray-forming the fins directly onto the surface (ensuring conformal contact) by means of a line-of-sight coating deposition technique through a spray mask featuring multiple small openings (ex: screen, perforated sheet). The mask blocks off part of the sprayed material, resulting in multiple coating segments that can be built up to form three-dimensional “pin” type fins.

The proposed technology is a quick additive material approach that differs from other existing fin manufacturing techniques by featuring certain key benefits:

Fins can be formed from various materials (copper, aluminum, steels, etc), which may be dissimilar to the substrate material to promote heat transfer. Cold spray relies on the deformation of the sprayed powder and locally at the interface with the substrate, thereby permitting most sprayed materials to adhere to a wide variety of substrate materials. As a result, one can select the fin/extended surface material almost independently of the plate material. Differential CTE between the materials is a significant concern for a contiguous surface but the discontinuous nature of the extended heat-transfer surface allows for a great deal of flexibility with respect to CTE mismatch.

By its nature, a kinetic spray coating is inherently adhered to the surface, eliminating the need for brazing or conductive adhesive.

A kinetic spray coating inherently has conformal contact with substrate, minimizing thermal contact resistances and promoting fin efficiency.

Possibility to produce a multitude of fin geometries (shape, size, height, etc) using commercially available inexpensive wire screen mesh or perforated sheets as mask.

Potential to easily use numerous different coating materials on a single substrate. For example, high temperature heat exchanger could create extended heat-transfer surfaces from stainless steel for the high-temperature portion of the heat-exchanger and then change to copper to enhance conductivity in a region exposed to lower temperatures.

Numerous fins are spray-formed simultaneously as the spray coating is applied on the surface, resulting in rapid manufacturing of a fin array that inherently has conformal contact with the surface for improved heat transfer efficiency.

Also, the coating procedure can be easily automated by mounting the spray gun on a robot, thereby reducing labour costs in comparison to machining or brazing operations.

Thus, according to one aspect, the invention provides a method of fabricating three-dimensional heat transfer enhancing features on a surface of a substrate, the three-dimensional heat transfer enhancing features having a predetermined desired shape on a surface of a substrate, the method comprising: using a mask having a pattern formed therein, the pattern being selected based on the predetermined desired shape of the three-dimensional heat transfer enhancing features to be fabricated; positioning the mask at an offset distance away from the surface; setting system conditions to appropriate settings; spraying a jet of impinging coating particles through the mask towards the substrate; and selectively blocking a portion of the jet with the pattern in the mask to fabricate the three-dimensional heat transfer enhancing features on the substrate.

According to another aspect, the invention provides an apparatus for fabricating three-dimensional heat transfer enhancing features on a surface of a substrate, the three-dimensional heat transfer enhancing features having a predetermined desired shape on a surface of a substrate, the apparatus comprising: a mask with a pattern formed therein, the pattern being selected based on the predetermined desired shape of the three-dimensional heat transfer enhancing features to be fabricated; an apparatus for positioning the mask at an offset distance away from the surface; a jet of impinging coating particles sprayed through the mask towards the substrate; and wherein a portion of the jet is selectively blocked with the pattern in the mask to fabricate the three-dimensional heat transfer enhancing features on the substrate.

Other aspects and advantages of embodiments of the invention will be readily apparent to those ordinarily skilled in the art upon a review of the following description.

### BRIEF DESCRIPTION OF THE DRAWINGS

Embodiments of the invention will now be described in conjunction with the accompanying drawings, wherein:

FIG. 1 illustrates an embodiment of the disclosed method and apparatus for fabricating three-dimensional heat transfer enhancing features on a surface of a substrate in accordance with the teachings of this invention; and

FIG. 2 illustrates the formation of pin-type fins on a substrate as successfully fabricated by the present Applicant using embodiments of the present invention.

This invention will now be described in detail with respect to certain specific representative embodiments thereof, the materials, apparatus and process steps being understood as examples that are intended to be illustrative only. In particular, the invention is not intended to be limited to the methods, materials, conditions, process parameters, apparatus and the like specifically recited herein.

### DETAILED DESCRIPTION OF THE DISCLOSED EMBODIMENTS

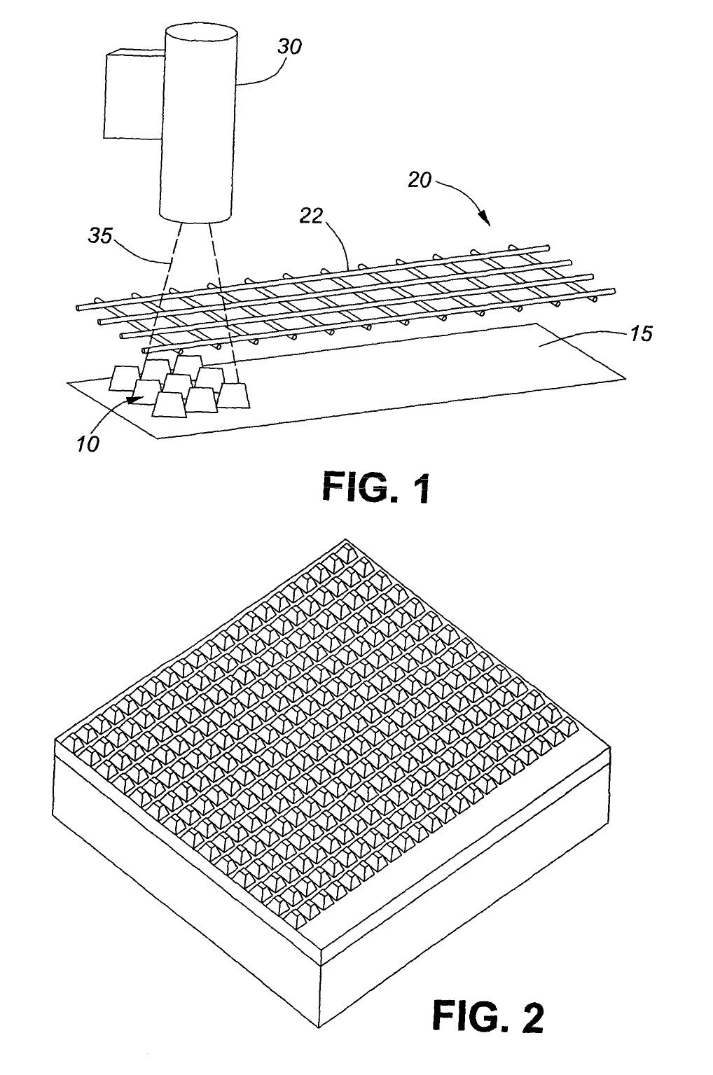

Referring to FIG. 1, disclosed is a method and apparatus for fabricating three-dimensional heat transfer enhancing features 10 on a surface of a substrate 15.

The three-dimensional heat transfer enhancing features 10 have a predetermined desired shape on a surface of a substrate 15. The substrate 15 can be any part or surface on which heat extended surfaces 10 are to be manufactured.

A mask 20 is supplied and a pattern 22 is formed in the mask 20, the pattern 22 being selected based on the predetermined desired shape of the three-dimensional heat transfer enhancing features 10 to be fabricated. The spray mask 20 could be (but not limited to) a wire screen mesh or perforated sheets. In use, the mask 20 is positioned between the spray gun 30 and the substrate 15.

A jet of impinging coating particles 35 is sprayed through the mask 30 towards the substrate 15. Preferably, the jet 35 is sprayed using a line-of-sight coating deposition technique such as (but not limited to) Kinetic Spraying. The jet 35 is preferably provided by a spray gun 30.

In this way, a portion of the jet 35 is selectively blocked with the pattern 22 in the mask 20 to fabricate the three-dimensional heat transfer enhancing features 10 on the substrate 15. The spray mask 20 featuring many small openings in a pattern 22 is positioned at a certain distance between the spray gun 30 and the substrate 15. The mask 20 blocks off part of the sprayed material 35 from the substrate 15, resulting in multiple coating segments that can be built up to form a three dimensional heat transfer enhancing feature 10. In one embodiment, these features could be pin type fins.

The spraying technique in accordance with the teachings of the present invention is not a typical masking approach. Parameters must be determined and set in order to specifically produce three-dimensional shapes on a surface. First, it has been discovered that the mask must be offset from the surface at a predetermined distance. Typically, the mask is placed right on the substrate itself. This can work fine if the mask is “open” or produces larger two dimensional stenciled shapes. However, the three dimensional shapes meant to be produced in accordance with the teachings of the present invention often in the range of millimeters and thus the mask is not of an “open” shape.

The use of an offset distance becomes even more important when kinetic spraying is used. This is because the process gases need to be expelled and this works best when the mask is offset. When the gases can be expelled, the kinetic spray jet can be deposited onto the substrate with improved adherence. The ideal stand-off distance between the mask and the substrate has been determined empirically. For the #12 mesh screen that the Applicant is currently using for high-temperature recuperator, a stand-off of approximately 3 mm has proven to be reliable.

Another parameter to predetermine is the velocity of the jet. The Applicant has discovered that velocity impacts the aspect ratio and adherence of the produced three dimensional features or shapes. In particular, it has been discovered that the faster the velocity component of the jet that is perpendicular to the surface, the higher the aspect ratio and the better the adherence qualities. Each sprayed material is characterized with its own “critical velocity” (the normal component of the particle-to-substrate impact velocity), below which the sprayed particles will simply not adhere to the substrate. The critical velocity is dependent on the sprayed material's properties. The critical velocity is a function of the material's physical properties (particle temperature dependent) and is the particle speed at which one observes a buildup of material, as known in the art. Embodiments of the invention do not rely on the particle speed but rather on the system conditions required to produce an acceptable coating (temperature and pressure).

Embodiments of the invention permit the possibility to produce masks 20 with advanced opening geometries (ex: openings shaped as airfoils to produce fins with airfoil cross-sections to minimize pressure losses in the flow).

The technique is not limited to pin fins: the mask can consist of long slits (of various shapes such as straight, wavy, or curved slits) to form rectangular typed fins.

As mentioned previously, the coating deposition technique may vary. Coatings may be produced by means of (but not limited to this list) thermal spray, cold spray, pulse-gas-dynamic-spray, kinetic metallization, low-pressure cold spray, etc. In a preferred embodiment, the deposition is cold spray. The Applicant has discovered that cold spray produces better quality three dimensional shapes with improved adherence and bonding.

The substrate 15 can consist of any type of part that requires features for enhanced heat transfer (fins). This includes flat or 3-dimensional (ex: curved) surfaces such as (but not limited to) heat sinks for electronics, heat exchangers, engine casings, cooling tubes, etc.

The mask 20 can consist of a variety of different porous media such as (but not limited to) screen material (available in many different wire diameters and mesh densities), perforated sheets, stretched wires, machined sheet (with slits or other desired fin profiles), etc.

The Applicant intends to use embodiments of the invention to manufacture rectangular/pyramidal pin fins on plate-like unit cells to be used on their ultra-compact wire-mesh plate-fin heat exchanger design. This is to be achieved using their existing Cold Spray equipment. For this purpose, the combined use of Cold Spray with a mask made from plain weave wire screen mesh is ideal given its relative simplicity, availability and low cost.

Referring to FIG. 2, preliminary testing of the technology has been carried out using the low-pressure Cold Spray coating technology and a mask consisting of wire screen mesh. Results of these tests have shown significant promise for this technique, as seen in FIG. 2 showing a successfully manufactured 2.5 in×2.5 in pin fin array. The pins produced in this example have a height of about 2.5 mm. This is very different than the usual thickness of thermal spray coating deposition in the range of tens of microns. Validation of the heat transfer performance of spray-formed pin fin arrays is currently underway. It is intended to have these testing trials and validation efforts become the focus of a peer-reviewed journal article. The Applicant envisions to integrate this technology into its ultra-compact wire-mesh plate-fin heat exchanger design as it is expected to yield many significant advantages with regards to cost and ease of manufacturing.

The discovery of using kinetic spray techniques to form such three-dimensional surfaces for heat transfer was not immediate. In general the mere thought of using kinetic spray for this type of application was unheard of and not expected.

The development of this technology as disclosed originated when the Applicant, Brayton Energy Canada (BEC), was looking for means of producing fins on the surface of their heat exchanger unit cells in order to promote heat transfer and improve the overall effectiveness of their heat exchangers. In addition, given the design projects being worked on at the time, BEC was looking for a solution that would result in minimal manufacturing costs and that would lend itself well to high volume production by means of automation.

Various alternatives were considered based on existing technologies. One general approach is to physically attach an existing fin array (often consisting of a corrugated sheet or foil, i.e. folded fins) to the unit cell surfaces. This may be achieved by a variety of techniques, the most common being brazing. Benefits of brazing include the formation of a conformal bond between the fins and unit cell surface, which provides structural rigidity and improves thermal conduction (no thermal contact resistance). However, while brazing is a proven technique, it requires significant manual part manipulation, long cycle times, extensive fixturing/tooling, and also limits subsequent welding operations resulting in additional design and manufacturing considerations. As such, this technique has been characterized with high manufacturing costs and does not lend itself well to automation for high volume production. Another technique to attach fins to a surface would be to use a thermally conductive adhesive, however given the elevated temperatures often encountered in BEC's heat exchanger applications, the use of adhesives is not appropriate.

Resistance welding was also considered, however research and development trials revealed this technique to be too aggressive, resulting in damage to the folded fin arrays. Other techniques were also considered (laser welding, e-beam welding, induction brazing), however all of these techniques required extensive development work and ultimately none would provide a cost effective solution in a high volume production scenario.

Given the difficulty in attaching folded fin arrays to the unit cell surface, BEC's focus was shifted to a different approach where fins would be machined directly from the unit cell surface. This implied a two-phase approach: (1) building up the unit cell surface thickness by means of coating deposition (production of a bulk coat layer), and (2) machining the fins out of the deposited bulk coat layer. While this two-phase approach would solve the issue of conformal contact between the fins and unit cell surface (the coating forms a metallurgical bond with the sprayed surface, which is ideal for heat transfer performance), each of these two phases featured their own set of specific challenges. In general, production of a thick coating layer is difficult for a variety of reasons. The need for a solution that would be viable in high volume production implied that only high-rate material deposition techniques should be considered (i.e. thermal spray). The issue with most thermal spray techniques however is that coatings tend to delaminate when built up beyond a certain thickness due to thermal effects and high tensile residual stresses. Following a series of tests, it was determined that the use of novel low-temperature coating deposition techniques (kinetic spraying) was necessary to allow for larger coating thicknesses to be achieved. In addition, careful selection and optimization of spray parameters was necessary to prevent warping of the sprayed surface (substrate) making machining of the fins challenging. Machining the fins from the bulk coat also posed a series of problems given their tight tolerances and typical small dimensions (common heat exchanger applications may feature fins as thin as 0.1 mm). Several machining options were successfully attempted, such as precision high speed milling, wire and sink EDM, grinding and finally ganged slitting saws. Nevertheless, the fundamental concept of applying a thick coating layer using a sophisticated deposition technique and then machining away most of it to produce thin fins is wasteful.

Efforts were made to build-up a coating directly into the final desired fin shape, thereby completely eliminating the need for fin machining and minimizing the amount of coating to be deposited. This was particularly difficult given the small dimensions of each feature and the limitations of the available spraying equipment.

Using a woven screen mask during cold spraying would block off part of the sprayed material, resulting in multiple coating segments building up to form fins. This solution is ideal and unique:
spraying the fins onto the unit cell surface ensures conformal contact to the surface (eliminating any thermal contact resistance) and is ideal for fin thermal performance.
numerous different fin geometries are possible from an assortment of readily available porous media materials (different opening sizes and shapes). It is simple and economical to use existing materials with regular patterns that can be used to produce effective arrays of fins for enhanced heat-transfer. The perfect example is the use of typical wire mesh to produce square pyramids. One could use perforated metal (circular openings) to produce conical-shaped fins, etc.
spray forming fins can be easily automated and lends itself well to high-volume production.
spray forming fins is rapid, cost effective, reduces coating waste and eliminates fin machining, which is ideal for the overall manufacturing process.
large variety of spray materials can be used, wholly or as a functional gradient, making the process highly flexible and versatile for many applications.
spray formed fins can also be produced on complex curved surfaces (not only flat surfaces), which is much more difficult to achieve if fin machining or fin attaching is involved.
embodiments of this approach do not impose limits on subsequent manufacturing steps (as does brazing, for example).
embodiments of the invention allow three-dimensional shapes with heights of about 1 mm to 4 mm.

While similar in theory to a stencil, this approach as disclosed is in fact quite different because in this case, functional 3-dimensional features (fins) are produced for the purpose of promoting heat transfer from the surface. The fins have a true structural bond to the substrate without the penalty of a contact resistance that one sees with an interference fit typical to finned tubes, etc. Most masking/stencil applications involve the application of a thin layer of material (ex: paint) which cannot be built-up into a functional component/feature. This approach should be viewed as an additive manufacturing technique for small sized three-dimensional components/features by using a mask, which has not been achieved elsewhere.

### Example of a Specific Embodiment on the Invention

Pin fins fabricated using the proposed technology are currently being used as part of the manufacturing process for a high temperature heat exchanger (recuperator) developed at BEC to be used in a microturbine power generation application. The recuperator consists of a stack of 50 unit cells (individual heat exchange elements), each featuring an array of spray deposited pin fins for enhanced heat transfer capability.

The pin fins were spray deposited using the Cold Spray coating process. A Plasma Giken PCS-1000 Cold Spray system was used with nitrogen as the process gas and a nozzle inlet pressure and temperature of 5 MPa and 950° C. respectively. The powder used was a gas atomized SS316Low-Ni alloy with a particle size distribution ranging from 10-45 μm in diameter. The stand-off distance between the nozzle and the mask was set at 30 mm, while the offset distance between the mask and the substrate was set to 3 mm. The mask consisted of a stainless steel 316 wire screen sheet, with 12 wires per inch (12-mesh) and a wire diameter of 0.81 mm.

The resulting pin fins are pyramidal in geometry, with a square base approximately 1.3 mm in width and a fin height of 1.5 mm. The following images show the pin fins at higher magnification. The proposed technology allowed for the fabrication of multiple pin fins with good adhesion to a dissimilar substrate material and no subsequent machining requirement, thereby offering a cost effective alternative to traditional fin manufacturing.

Numerous modifications may be made without departing from the spirit and scope of the invention as defined in the appended claims.

What is claimed is:

1. A method of fabricating three-dimensional heat transfer enhancing features on a surface of a substrate, the three-dimensional heat transfer enhancing features having a predetermined desired shape on a surface of a substrate, the method comprising:
using a mask having a pattern formed therein, the pattern being selected based on the predetermined desired shape of the three-dimensional heat transfer enhancing features to be fabricated;
positioning the mask at an offset distance away from the surface;
setting system conditions to appropriate settings;
spraying a jet of impinging coating particles through the mask towards the substrate; and
selectively blocking a portion of the jet with the pattern in the mask to fabricate the three-dimensional heat transfer enhancing features on the substrate.

2. The method of claim 1, wherein the line-of-sight deposition technique is thermal spraying or kinetic spraying.

3. The method of claim 1, wherein the mask is a wire screen mesh or perforated sheet.

4. The method of claim 1, wherein the thee-dimensional heat transfer enhancing features are pin type fins.

5. The method of claim 1, wherein the system conditions include pressure and temperate of the spray.

6. The method of claim 1, wherein the mask is #12 mesh screen and the offset distance is 3 mm to fabricate a high-temperature recuperator.

7. An apparatus for fabricating three-dimensional heat transfer enhancing features on a surface of a substrate, the three-dimensional heat transfer enhancing features having a predetermined desired shape on a surface of a substrate, the apparatus comprising:
a mask with a pattern formed therein, the pattern being selected based on the predetermined desired shape of the three-dimensional heat transfer enhancing features to be fabricated;
an apparatus for positioning the mask at an offset distance away from the surface;
a jet of impinging coating particles sprayed through the mask towards the substrate; and
wherein a portion of the jet is selectively blocked with the pattern in the mask to fabricate the three-dimensional heat transfer enhancing features on the substrate.

8. The apparatus of claim 7, wherein the line-of-sight deposition technique is thermal spraying or kinetic spraying.

9. The apparatus of claim 7, wherein the mask is a wire screen mesh or perforated sheet.

10. The apparatus of claim 7, wherein the thee-dimensional heat transfer enhancing features are pin type fins.
